(19) United States
(12) Patent Application Publication
(10) Pub. No.: US 2023/0401969 A1
(43) Pub. Date: Dec. 14, 2023

(54) SPEECH AND LANGUAGE CORRECTING SYSTEM

(71) Applicant: EZSpeech Inc., Morganville, NJ (US)

(72) Inventors: Adelina SAMUELS, Morganville, NJ (US); Firuza Mansurovna ESHONOVA, Moscow (RU)

(21) Appl. No.: 17/835,531

(22) Filed: Jun. 8, 2022

(51) Int. Cl. G09B 5/06; G10L 15/25; G06V 40/16

(52) U.S. Cl. CPC G09B 5/065; G10L 15/25; G06V 40/174

(57) ABSTRACT

A computer-implemented automated speech and language system to assist in correcting speech and language disorders in children and adults. The system has a device connected to a camera and a processor. The system also includes a non-transitory machine-readable medium comprising instructions stored therein, which when executed by the processor, cause the processors to perform operations. The operations performed by the non-transitory machine-readable medium are accessing or creating a user profile, selecting an exercise to be performed by the user, detecting the user's face and alignment in front of the camera, determining a face key point data, determining an actual data model based on the face key point data, determining a reference model based on a correct performance of the exercise scaled for physical characteristics of the user, comparing the actual data model with the reference model, interpreting whether a result of the comparison between the actual data model and the reference model is within predetermined parameters; and providing a feedback based on the interpretation.

### BACKGROUND

The present invention generally relates to assisting in correcting speech and language disorders in children and adults. More specifically, the present invention relates to a computer-implemented speech and language system to assist in correcting speech and language disorders in children and adults.

A large number of children and adults struggle with speech and language development. Twenty percent of kids between ages between 3 and 10 exhibit speech and language issues. The delayed language and speaking milestones are generally a sign of a language or speech delay or disorder. Language and speech disorders can exist together or by themselves. Examples of speech disorders are difficulty of forming specific words or sounds correctly, or difficulty with making or pronouncing full words or sentences, such as dysarthria, apraxia, and dysphasia. Examples of language disorders are language development delays (the ability to understand and speak develops more slowly than it is typical), dysphasia (an inability to produce words clearly and use verbal expressions to communicate wants and needs), and aphasia (difficulty understanding or speaking parts of language due, for example, to a brain injury).

Language and/or speech disorders can occur together with other learning disorders that affect reading and writing. Children with language disorders may feel frustrated that they cannot understand others or make themselves understood, and they may act out or withdraw. Language or speech disorders can also be present with emotional or behavioral disorders, such as attention-deficit/hyperactivity disorder (ADHD) or anxiety. Children with developmental disabilities including autism spectrum disorder may also have difficulties with speech and language. The combination of challenges can make it particularly hard for a child to succeed academically and socially. It is therefore crucial a proper assessment is implemented to establish a speech problem that a child has, its etiology and method of treatment.

Unfortunately, there is a shortage of trained speech-language pathologists (SLPs) that can work with children suffering from speech and language disorders. This shortage is due, in part, to the limited number of openings in graduate programs and the increased need for SLPs as their scope of practice widens, the autism rate grows, and the population ages. Schools worldwide are feeling this shortage the most.

While types of treatment will typically depend on the severity and type of the speech and/or language disorder, most treatment options include physical exercises that focus on strengthening the muscles that produce speech sounds and speech therapy exercises that focus on building familiarity with certain words or sounds. For example, SLPs work with their patients on performing exercises for improving muscle strength, motor control, and breath control and saying word pairs or sentences that contain one or more different speech sounds.

Further, it is most important for the effective treatment of speech and language disorders that patients practice daily the required exercises and regularly see their SLP. However, the lack of SLPs, expense of online and offline sessions and sometimes lack of motivation to do the exercises in the young patients deter from the progress of the treatment.

There is therefore a need to provide a system that would facilitate an effective treatment of speech and language disorders, and more specifically there is a need to provide a computer-implemented automated speech and language system to assist in treating speech and language disorders in children and adults with or without SLPs being present during a treatment session.

The system preferably can provide a decision support system for SLPs and institutional users, such as schools, speech centers, and insurance companies, and the like. In particular, the system preferably identifies a baseline as a result of an initial assessment of a user, compares the user's results to the age expected levels of performance, generates an individualized plan of care (IPOC) so that the user reaches the age expected levels of a speech output. The IPOC assigns a series of exercises that can be modified by the system according to the user's progress. The system can allow a trained SLP to modify the IPOC based on her/his professional expertise. A progress report can be generated that includes the effectiveness of the specific treatment plan and exercises. This helps to eliminate issues related to subjective assessments by SLPs with a variety of qualifications, experiences, and education of a treatment plan and progress.

### SUMMARY

In one aspect, the present invention provides a computer-implemented automated speech and language system to assist in correcting speech and language disorders in children and adults. The system has a device connected to a camera and a processor. The system also includes a non-transitory machine-readable medium comprising instructions stored therein, which when executed by the processor, cause the processors to perform operations. The operations performed by the non-transitory machine-readable medium are: accessing or creating a user profile, selecting a recommended exercise to be performed by the user, detecting the user's face and alignment in front of the camera, determining a face key point data, determining an actual data model based on the face key point data, determining a reference model based on a correct performance of the exercise scaled for physical characteristics of the user, comparing the actual data model with the reference model, interpreting whether a result of the comparison between the actual data model and the reference model is within predetermined parameters; and providing a feedback in real-time based on the interpretation.

In another aspect, the present invention provides a computer-implemented automated method to assist in correcting speech and language disorders in children and adults. The method provides for accessing or creating a user profile and then selecting a recommended exercise to be performed by the user. Further, the method includes detecting the user's face and alignment in front of the camera and determining a face key point data. The method includes determining an actual data model based on the face key point data and determining a reference model based on a correct performance of the exercise scaled for physical characteristics of the user. The method further includes comparing the actual data model with the reference model and interpreting whether a result of the comparison between the actual data model and the reference model is within predetermined parameters. Lastly, the method includes providing a feedback in real-time based on the interpretation.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a computer-implemented automated speech and language system to assist in correcting speech and language disorders in children and adults according to embodiments of the invention;

FIG. 2 depicts a diagram of a computer vision (CV) module according to embodiments of the invention;

FIG. 3 depicts a reference model determined by scaling an optimal model using the user's actual facial contour, characteristics and physical features that are determined from the user's facial key points according to embodiments of the invention;

FIG. 4 depicts a diagram of a tongue processor component according to embodiments of the invention;

FIG. 5 depicts a video self-modeling (VSM) approach according to embodiments of the invention;

FIG. 6. depicts a use case diagram according to embodiments of the invention; and

FIG. 7 depicts a flow diagram illustrating a method for using the computer-implemented speech and language system according to embodiments of the invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

A large number of children and adults struggle with speech and language development. In children, the delayed language and speaking milestones are generally a sign of a speech delay or disorder. Examples of speech disorders are difficulty of forming specific words or sounds correctly, or difficulty with making or pronouncing full words or sentences, such as dysarthria (e.g., a speech disorder when a child knows what to say, understands what message they are trying to deliver but cannot do so due to neurological, physiological or anatomical difficulties and disorders, such as, cleft lip/palate, neonatal asphyxia, and cerebral palsy). Examples of language disorders are language development delays (the ability to understand and speak develops more slowly than it is expected), auditory processing disorder (difficulty understanding the meaning of the sounds), and aphasia (difficulty understanding or speaking parts of language due, for example, to a brain injury). Unfortunately, there is a shortage of trained speech-language pathologists (SLPs) that can work with children and adults suffering from speech and language disorders.

Most treatment for a language or speech delay or disorder include options such as speech therapy exercises that focus on physical exercises that strengthen the muscles that produce speech sounds and build familiarity with certain words or sounds. SLPs work with their patients on practicing sounds, words, sentences, and free speech levels. These contain targeted sounds in isolation, combination with vowels, initial, medial and final position of the word.

For the effective treatment of speech and language disorders it is imperative that patients practice daily. Moreover, the patients must perform the exercises correctly and focus on details of the exercises that ensure the progress and, ultimately, successful completion of the treatment. The user (patient) and/or his or her guardian often does not have a required expertise to correctly perform the exercise and identify mistakes when she/he performs the exercise. In case when the user is a child, parents also lack proper training to guide the child to correctly perform the exercises. As access to SLPs is not always readily available, it is often that the exercises are performed incorrectly, and even daily performance of the exercises do not bring the intended results.

In order to mitigate the forgoing issues, the present invention provides a computer-implemented system that facilitates an effective treatment of speech and language disorders in children and adults without SLPs being during a treatment session. According to embodiments of the present invention, the system assists its user to improve and/or increase muscle strength, agility and stability that in turn helps the users in improving their speech output quality. The system provides visual cues and verbal feedback that helps with self-correction and training process, that leads to a better carry-over and provides better results in therapeutic intervention. The system provides a decision support system for SLPs and institutional users, such as schools, speech centers, and insurance companies, and the like. In particular, the system provides real-time feedback during performing of the exercise and grading upon completion of each exercise. Those parameters are included in progress reports generated by the system. During each session the user uses his exercise routine assigned at the time of the initial assessment described below. These reports are accessible by the treating SLP as well as other entities involved in a care of a user. This eliminates issues related to subjective assessments by SLPs with a variety of qualifications, experiences, and education of a treatment plan and progress.

More specifically, the system of the present invention configured to determine a baseline for each user by identify problems to be corrected (e.g., which user's sounds are unexpected and/or disordered for the specific age). The system determines the baseline based on an initial evaluation of the user. The initial information is collected, such as name, age, gender, and the like. In addition, the following evaluation parameters are determined: evaluation of facial structure (symmetry, anomalous movement), jaw assessment (mobility and symmetry), bite and teeth assessment, lip assessment, sound assessment, and tongue assessment. Other assessments and information can be included that is necessary to determine the baseline for a specific user.

Further, the system sets a treatment goal based on comparison between the baseline assessment and an age expected levels of performance, and automatically determines and recommends an individualized plan of care (IPOC) that contains a personalized set of exercises to be performed by the user to achieve the treatment goal, such as the age expected levels of speech output. The system allows a trained SLP to modify the IPOC based on her/his professional expertise.

Based on the individualized plan of care, the system guides the user throughout the set of exercises, assessing precision of performance of the exercises using a computer vision (CV) and sound processing module with artificial neural networks (ANN). The system is configured to provide personalized feedback in real-time and assessment for a specific sound production, word production, free speech output levels, exercise, practice and/or exercise module via voice, text and animation. The system assesses each repeat (i.e., recitation) of the exercise or practice on 0-100% scale as to how precise the user performs the exercise as compared to a model of the exercise performed by a trained SLP. There can be, preferably, seven to ten repeats of each exercise and/or practice. The assessment is expressed by a precise number (e.g., 10%, 20% 93% and so on). Upon completion of the exercise (i.e., completion of all repetitions), the system generates a rating (grading) for the overall performance of the exercise (of all the repeats). The rating has a scale between 0-100%, and preferably, grouped as follows: 90%-100% (super), 70-90% (good), 40%-70% (nice try), and less than 40% (too many mistakes). The system is configured to provide, upon completion of exercise, daily log reports using the assessment and ratings that can be accessed at any time and are accumulated in a user's chart. In addition, the system generates progress reports upon completion of the exercise that can include all the forgoing assessments, ratings, and other data, such as recommendations and/or to modifications of the individualized plan of care, whether the user followed the individualized plan of care, and how regularly the user performed the exercises.

To achieve the high level of precision in the user's performance of the exercise, the system configured to create a reference model of the user performing the exercises and compare the reference model against an actual model of the user performing the exercise in real-time. The reference model is determined based on an optimal model of the exercise performed by a trained SLP but scaled for the user's actual facial contour, characteristics and physical features.

The set of exercises can cover voice (pronunciation and volume of sounds), mimics (lips, tongue, cheeks, teeth position and movement), and gestures (fingers and hands positions and movements). According to embodiments of the invention, there can be eight exercise modules. For each exercise module there are exercises for the development of speech apparatus (e.g., facial expressions, tongue exercises, gestures and the like), the development of sounds (voice) by using specific sounds in various types of scenarios (such as in syllables, in words, in phrases, and in sentences and texts). Moreover, the specific sound that the user is working with will be used in different variations, such as at the beginning of the word, in the middle and at the end, and taking into account combinations of neighboring sounds, for example, nearby consonants or vowels. The system is also configured to allow additional texts and words to be added to the system by, for example, a user or SLP. For example, the following modules can be included:

TABLE I

| Module | Sounds |
|---|---|
| Bilabial | p, b, m, w, a, u, e, o |
| Labio-Dental | f, v |
| InterDental | th-voiced and voiceless |
| Alveolar | t, d, s, z, n, l, r |
| Alveolar-palatal | sh, ch, zh, j |
| Palatal | J |
| Velar | k, g, ng |
| Glottal | H |

To clarify, the system is configured to include additional exercises and/or modules to achieve various treatment goals according to the individualized plans of care.

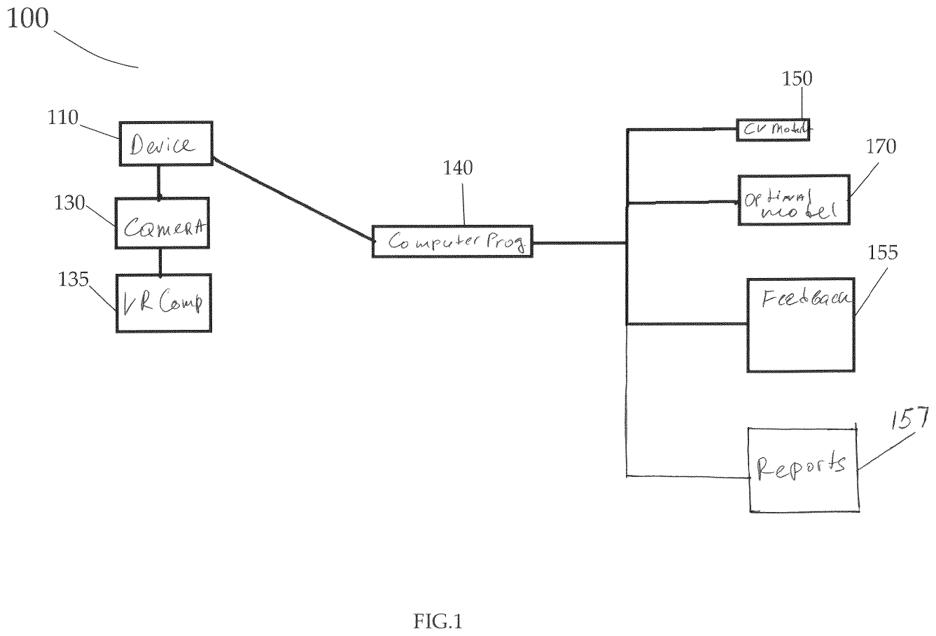

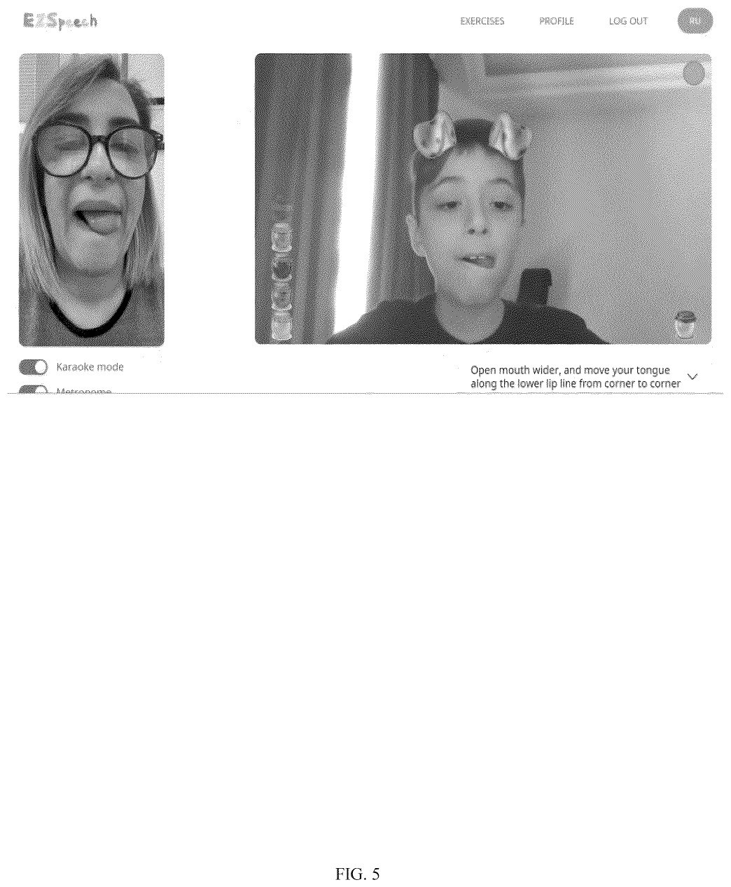

FIG. 1 illustrates an exemplary embodiment of a computer-implemented speech and language system 100 to assist, for example, a treating professional, in correcting speech and language disorders in children and adults. As shown in FIG. 5, the system 100 uses a video self-modeling (VSM) approach where a user can view herself/himself while performing an exercise that assists the user to improve and increase muscle strength, agility and stability that in turn helps the user in improving her/his speech output quality. The system provides visual cues, text and verbal feedback that helps with self-correction and training process, that leads to a better carry-over and provides better results in therapeutic intervention.

According to embodiments of the invention, each of the constituent parts of the system 100 may be implemented on any computer system suitable for its purpose and known in the art. Such a computer system can include a device 110, such as a personal computer, mobile device (e.g., a mobile phone or tablet), workstation, embedded system, game console, television, set-top box, or any other computer system. Further, the device 110 can include a processor and memory for executing and storing instructions, a software with one or more applications and an operating system, and a hardware with a processor, memory and/or graphical user interface display. The device 100 may also have multiple processors and multiple shared or separate memory components. For example, the computer system may be a clustered computing environment or server farm.

According to embodiments of the invention, the system 100 includes a front-facing camera 130. The camera 130 can be embedded into the device 110. For example, a desktop computer or a game console can be used as the device 110, such that the desktop computer or game console is connected by a wired or wireless connection to camera 130. In these cases, camera 130 may be a webcam, a camera gaming peripheral, or a similar type of camera. However, it should be noted that a wide variety of devices 110 and camera 130 implementations exist, and the examples presented herein are intended to be illustrative only.

It is preferred that the camera 130 is arranged at a distance from the user that allows the device 110 to acquire a sequence of images, such as a video sequence, of the user's face movement. Preferably, the user should maintain a constant orientation and position with respect to the camera 130 to allow for a steady sequence of images.

The device 110 has an implemented computer program 140 that operates one or more modules remotely via cloud computing services accessible via network connection. That is, the device 110 can be connected over a network to one or more servers (not shown).

According to embodiments of the present invention, the implemented computer program 140 has an optimal model 170 for each exercise. The optimal model 170 is predetermined and is based on the performance of the exercise by a trained treating professional, for example, a qualified SLP.

According to embodiments of the present invention, the implemented computer program 140 can include a computer vision (CV) module 150.

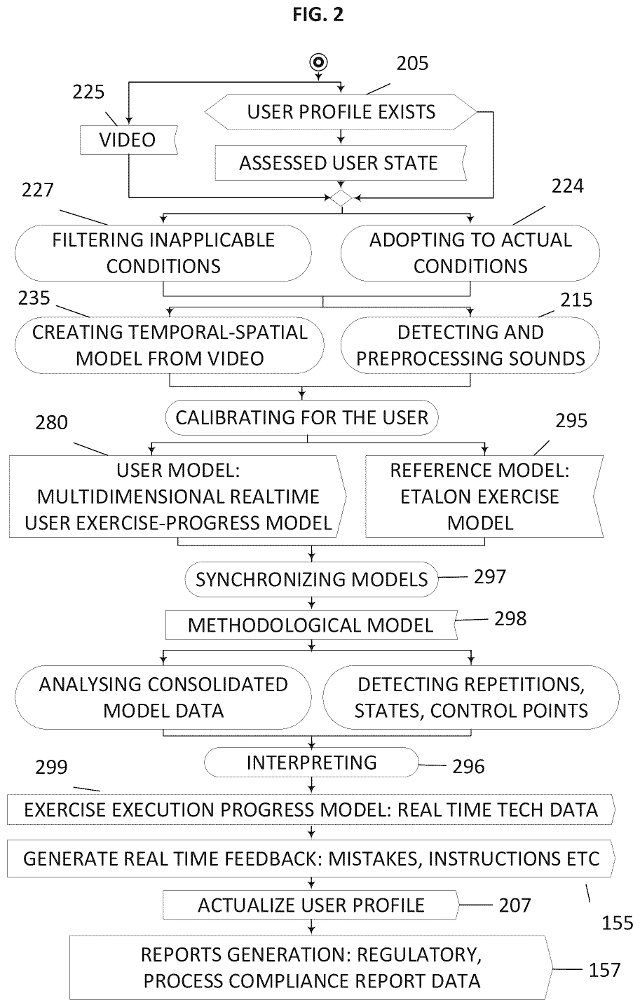

According to embodiments of the present invention, as illustrated in FIG. 2 the computer program 140 detects a user profile 205 if the user has previously created the user profile. Alternatively, the computer program 140 will prompt the user to establish the user profile 205 that can include the user's information (name, age, gender) and the initial evaluation of user. Based on the assessment of the user, as described above in paragraphs [0027] and [0028], the computer program 140 sets a treatment goal based on the baseline assessment and determines the individualized plan of care (IPOC) that contains a personalized set of exercises to achieve the treatment goal. The IPOC can be modified by a treating professional based on its professional opinion.

As illustrated in the diagram shown in FIG. 2, the CV module 150 is configured to first detect from a video stream 225 common parameters and normalize video data. The CV module 150 can detect the user's face position, video data format, data compliance and connectivity compliance. The video data then normalized by filtering inappropriate conditions 227 (e.g., too bright, too dark images, contrast issues), and adopting the video stream 225 to actual conditions 224 by transforming the video stream 225 by utilizing manipulations at multiple levels (signal, structural, or semantic) to meet diverse resource constraints and user preferences while optimizing the overall utility of the video.

The user can be provided with visual, voice and text aids to assist the user with proper positioning in front of the camera 130, i.e., the user looks directly into the camera without turning away and does not make any movements that are not related to the performance of the exercise. For example, a “mask” in the form of bunny ears, crowns, hats and the like can be used to provide the user with visual aids for proper positioning. The user can receive a message via voice or text if the CV module 150 detects a foreign object or another person in the frame of the camera.

According to embodiment of the present invention, the CV module 150 includes a set of custom connected algorithmic modules and artificial neural networks (ANN) configured for predicting, for set of image frames, a set of key points, their temporal and semantic (meaningful features) parameters indicating the movements of the user's face features and muscles to determine a multi-dimensional face data model 235, including face mesh, temporal, semantic (meaningful features, face parts specific) and key points data. In particular, 90-120 key points can be used. General valuation data structure and machine learning (ML) model arrangement for evaluating a specific motion pattern has been generally disclosed in the U.S. Patent Publication 2021/0209349 A1 and U.S. Patent Publication 2021/0209350 A1, the entire disclosures of which are herein incorporated by reference.

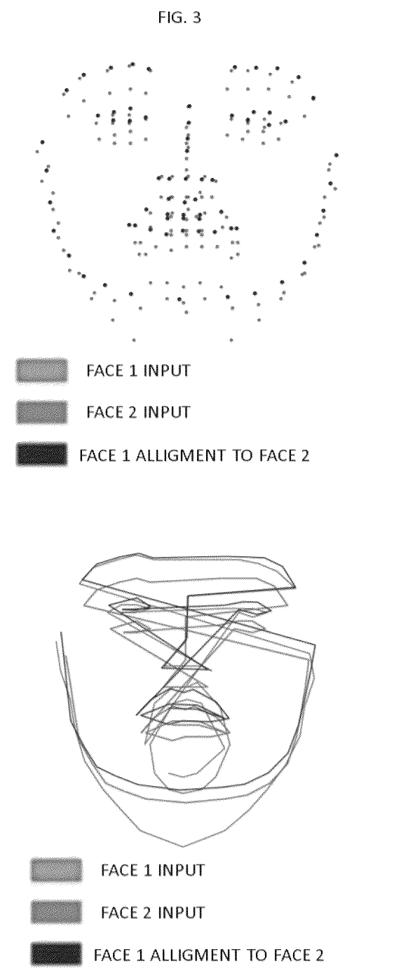

As illustrated in FIG. 3, the key points and/or, for example, two-dimensional (2D), three-dimensional (3D) mesh and/or 3.5-dimensional (3.5D) model are extracted from the image input. In addition, temporal appearance of the user's face features and temporal sequence of 2D, 3D or 3.5D appearance of the facial features are extracted to optimize a face key point data (temporal-spatial) model 235. Finally, in combination with face position detection input and key points input that determine a mask input, the face key point data model 235 is determined.

Further, the subset of facial key points can automatically be selected. For different exercises the generalized facial temporal-spatial model is used, but different sub-meshes of facial mesh can be selected for tracking the user's facial impressions.

It is important to note that in addition to the embodiment illustrated by this disclosure, any other representation of the user's face can be used for describing the user's face movement, such 2D, 3D or 3.5D mesh of the user's face. The 3.5D representation is preferred as it includes spatiotemporal trajectory features, which contain perspective projected horizontal and vertical, time, and depth information thereby providing the most accurate representation of the user's face movements and position. By tracking the positions of the face's key points or any other representation of the user's face body in the sequence of image frames, the user's movements when performing the exercise can be evaluated. The representation can depend on the type of the camera 130, which can be for example a 2D-camera, a 2.5D-camera or a 3D-camera. That is, the face's key points predicted for each image frame can be for example 2D-points, 2.5D-points or 3D-points.

According to embodiments of the present invention, as shown in FIG. 2, the CV module 150 can include a sound detection component that analyzes user's voice input by decomposing sound and volume into a 2D spectrogram to provide a sound-specific model data 215.

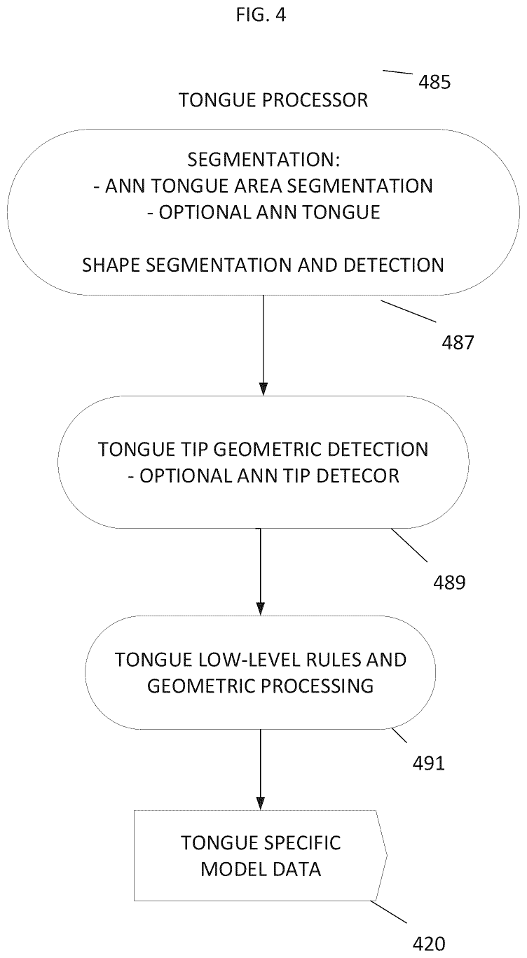

In addition, to provide the most accurate actual data model 280, the CV module 150 can include a tongue-specific processor component 485, the exemplary diagram of which is shown in FIG. 4. More specifically, the tongue-specific processor component 485 applies tongue area segmentation and/or tongue shape segmentation 487 and tongue tip geometric detection 489 to tongue low-level rules and geometric processing 491 to derive a tongue-specific model data 420.

As shown in FIG. 2, all input data described above is calibrated, including, but not limited to, the face key point data model 235, the sound-specific data 215 and/or tong-specific data 420 to determine an actual data model 280 (user model) of the user performing the exercise in real-time.

According to embodiments of the present invention, the face key point data model 235, the sound-specific data 215 and/or tong-specific data 420 are determined separately and simultaneously in real-time but can be interdependent. For example, when the user performs the exercise involving voice and facial expression (both the face key point data model 235 and the sound-specific data 215 are determined), if the user properly pronounces a sound, but the muscles' movement is incorrect, the system determines the exercise being performed incorrectly. That is, the system 100 is configured to train the user to correctly use the articulatory apparatus (facial expressions) while properly pronouncing sounds (voice).

A set of specific labeled datasets is a part of the technological stack, allowing to get the target ANN characteristics. These datasets are semi-automatically and manually generated, gathered, labeled, validated and accessed. For preprocessing and filtering large raw datasets specific ANNs and algorithms were created.

According to embodiments of the present invention, as illustrated on FIG. 2, the CV module 150 is configured to develop a reference model 295 The reference model 295 is determined by scaling the optimal model 170 using the user's actual facial contour, characteristics and physical features that are determined from the user's facial key points (as shown in FIG. 3).

The actual data model 280 is compared to the reference model 295 to determine mistakes made by the user during the performance of the exercise. More specifically, as shown in FIG. 2 and according to embodiments of the present invention, the actual data model 280 and the reference model 295 are synchronized in multidimensional space synchronizing model 297, to be consolidated then with a methodological model 298 that includes a set of rules regarding correct performance of the exercise. For example, methodological model 298 can include rules for correct muscles' movements, facial expressions, gestures and voice. The models are then analyzed and interpreted as shown in FIG. 2 to determine mistakes made by the user during the performance of the exercise thereby configuring an exercise execution progress model 299. The exercise execution progress model 299 has real-time technical data related to the actual execution of the exercise by the user.

According to embodiments of the present invention, as shown in FIG. 2, the computer program 140 is configured to generate a feedback 155 to the user. The feedback 155 can be in the form of text, voice, animation or combination of various techniques known in the art. The feedback 155 can be provided immediately and in real-time at the end of each repetition of the exercise by the user if a mistake was determined. Preferably, the user repeats the same exercise ten times receiving the feedback 155 for each repetition. During each repetition the system also assesses each repetition and records the precision with which the user is performing the exercise. The assessment is expressed by a precise number (e.g., 10%, 20% 93% and so on). Upon completion of the exercise (i.e., completion of all repetitions), the system generates a rating (grading) for the overall performance of the exercise (of all the repeats). The rating has a scale between 0-100%, and preferably, grouped as follows: 90%-100% (super), 70-90% (good), 40%-70% (nice try), and less than 40% (too many mistakes). The system is configured to provide, upon completion of exercise, daily log reports using the assessment and ratings that can be accessed at any time and are accumulated at the user profile 205, which is updated in real-time to configure an actualized user profile 207. The actualized user profile 207 can include synchronized and updated assessment and rating information relating to the user and modified and/or updated individualized plan of care, progress report, and other data, such as recommendations and/or to modifications of the individualized plan of care, whether the user followed the individualized plan of care, and how regularly the user performed the exercises.

As illustrated in FIG. 2, in addition to the feedback 155, assessment and ratings, the system 100 can be configured to provide reports 157. The reports 157 are generated by the system upon completion of the exercise, and can include user statistics and data recommendations, modifications to the individualized plan of care, whether the user followed the individualized plan of care, how regularly the user performed the exercises, and other information that can be used by treating professionals, such as SLPs, special care centers, schools, hospitals, insurance companies and the like.

According to embodiments of the present invention, as shown in FIG. 5, the computer program 140 can be operated by the user in one of two modes—video mode and karaoke mode. In the video mode, the user repeats the exercise after the video that shows the correct execution of the exercise, for example, performed by a trained SLP, is demonstrated a single time. In the karaoke mode, the user performs the exercise along with the video that that shows the correct execution of the exercise, and the video is continuously shown during the user's performance of the exercise.

A specific pace of the exercise can be predetermined by the system 100 and can be regulated by a signal (e.g., beeping sound). That is, if the system 100 determines that the user cannot perform the exercise at the recommended pace for the specific exercise, the system 100 will adjust the pace of the exercises by slowing down the pace of the signal.

According to embodiments of the present invention, the computer program 140 can derive a single time period for each exercise that has the start point of the period and the end point. Each time period for each exercise is determined as a time difference between a start point and an end point. For each feedback 155, a single period for each exercise is evaluated.

According to embodiments of the invention, the system 100 can also include a virtual reality (VR) component 135. The VR component can be realized by the device 110 or, alternatively, a separate VR device, for example, VR headsets offered by manufactures like Samsung, Oculus, Hewlett Packard and the like. The VR device for example, can include one or more speakers, microphones, and/or headphones. A VR environment may be displayed on the display to provide a computer simulation of real-world elements. Such immersive VR environment can aid and improve the user's cognitive interactions while performing the exercise. In particular, the VR environment can aid the user in demonstrating how to properly perform the exercise through animation.

The VR component can greatly aid users who suffer from attention deficit disorders (ADD), attention deficit hyperactivity disorder (ADHD) and/or autism spectrum disorders to focus on properly performing the exercise and follow the instructions provided by the system and/or a treating professional. The VR component can be used for individual sessions or group exercises.

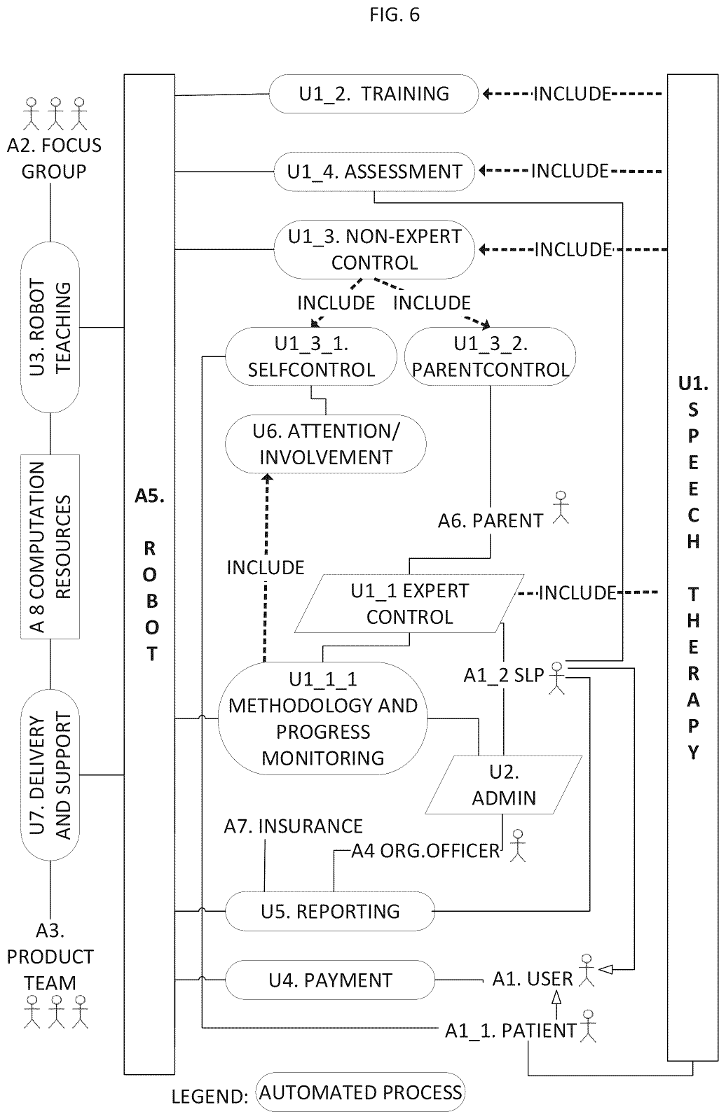

FIG. 6 illustrates a use case process flow of the system 100. A1_1 identified as the user. A1_2 is identified as SLP. FIG. 6 includes patients and therapists A2 that do not directly employ the system (do not have user accounts) but are involved in ANN training. Product team A3 support the user A1_1 and assist in ANN training. In certain instances, a corporate user A4 can assist A1_2 when A1_2 is employed by an institution such as speech centers, rehabilitation centers, hospitals, and schools. The computer program 140 is identified as A5. Robot.

As illustrated in FIG. 6, core functions U1 provide a tool for self-training speech therapy, which includes:
training (U1_2) where the system 100 configured to demonstrate a set of exercises and the user A1_1 can perform the exercises when they see themself on the screen (also shown in FIG. 5);
non-expert control (U1_3) where the system 100 provides tools enabling the user A1_1 to control the performance. Those tools include real-time feedback so the user A1_1 can correct the mistake while performing the exercise such as metronome, voice and text assistance, as well as tool to keep the user involved A1_1, such as animation, masks and other gamification tools U6 (prizes, tokens, etc.). Non-expert control can be executed by a child (U1_3_1) or his/her parent (U1_3_2); and
assessment (U1_4) where the system 100 interprets and assesses the accuracy of performance of the individual user A1_1 and grade the performance (super, good, nice try and so on) giving the exact percentile rating (from 0% to 100%).

All of the above functionalities are fully automated.

A process which is not automated is U1_1 Expert control. Because while the initial assessment is performed by the system and IPOC is generated by the system, the SLP can manually modify both as she/he feels necessary. Furthermore, the SLP may communicate with a parent to receive any other feedback. The non-automated feedback is optional and is not required by the system 100.

As shown in FIG. 6, methodological support and progress monitoring U1_1_1 is an ongoing process to expand the database of exercises. For example, the SLP may use words and sentences and text pre-loaded in the APP (over 400 isolated words and around 500 words in the text), at the same time the SLP (U1_1) has an option to use any words/sentence or text which are NOT preloaded in the system. Expert also can review the progress report.

In addition, as shown in FIG. 6, the system 100 allows for the following functionalities:
U2—Administration-applicable for corporate users configured to set up accounts, control etc. for corporate;
U3 ANN training;
U4—payments (subscription or license model);
U5—reporting:
   Dashboard—Stats and progress. Diagrams which illustrate the status and progress as of given day and/or for the specific period,
   Detailed reports to insurance—The reports are generated periodically (10-20-30 etc. sessions) and provide more detailed description of the progress (or absence of it). If the dashboard provides a number, for example 40% correct, the report to insurance provides details behind that number, e.g., exact mistakes. Different insurance companies use different formats, system 100 uses the best practice to include all necessary data. The SLP can and will modify report. The automation of the reporting substantially saves time for SLP to draft reports to be provided to insurance
U6-aims to keep a child user A_1 engaged and to keep the correct position.

Further, user A1_1(human) who signs into the program, will enter his/her information limited to name and age, then the user A1_1 will have an option of giving an SLP assigned to the user's case access, as well as give access to the entity that covers/pays for the SLP's service (if applicable). That is, user A1_1 is connected to A1_2/SLP who is connected to U1_1. Expert Control all during provision of speech therapy via exercise routine, and automatization practices during the full therapy cycle. The individualized plan of care is generated and recommended to the user A1_1 by the computer program 140 based on the data gathered during the initial assessment. This data will be transferred into a document that will describe user's A1_1 abilities and disabilities. This document contains the established baseline and an age expected levels of performance of the user A1_1. Then the IPOC based on this data is will be designed. The data will be automatically accessible by A1_2/SLP who is connected to U1_1, so that these could be involved in the process. These will assure Methodological Support and Progress Monitoring is automated/U1_1_1/. It will enable anyone including but not limited to U1_3, U1_3_1, U1_3_2, U6, U2 have access to IPOC goals which will be constantly reassessed based on the assessment, ratings and related statistics and data. As illustrated in FIG. 6, this will ease and automate the process of assessment, design of treatment plan, progress, use, and payment of the therapy cycle.

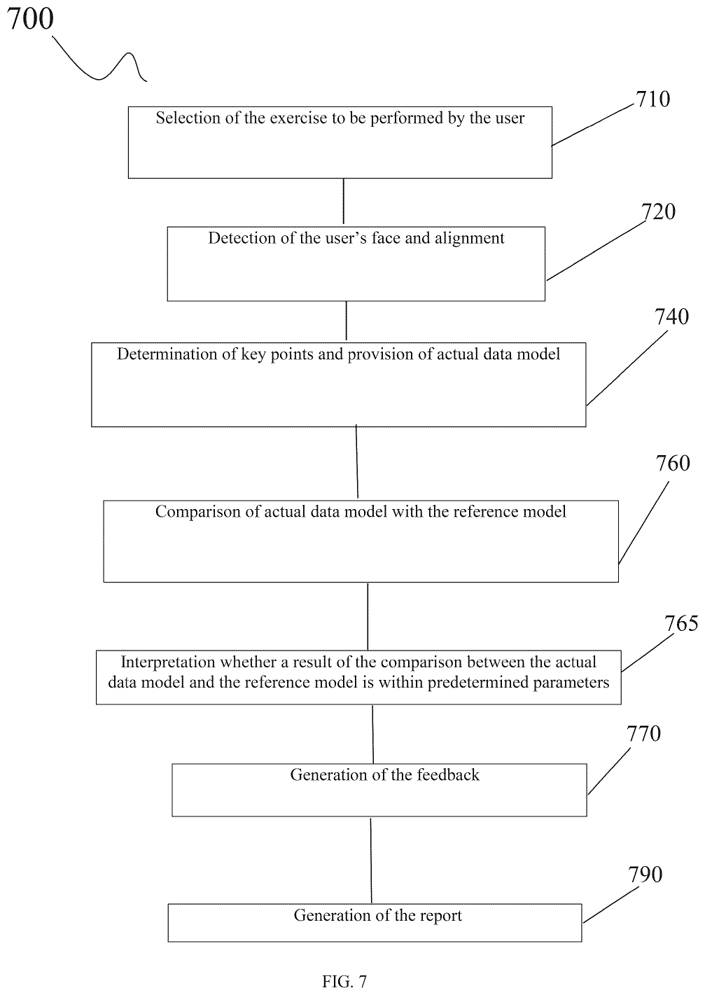

FIG. 7 is a flow diagram illustrating a method 700 for using the computer-implemented speech and language system 100 in according to the embodiment of the preset invention. The method 700 includes installation of the computer program 140 or receiving access to the same via network connection. In stage 710, the user or a treating professional, such as an SLP, accesses an exercise to be performed by the user based on an individualized plan of care. The computer program 140 can be configured to display, using output means, a selection of exercises. The selection of exercises can be automatically predetermined or determined by the treating professional. The choices of exercises, including their level of difficulty, that are available to the user can depend on a predetermined plan of care with a specific baseline that is based on an initial assessment. Further, the available selection of exercises can also depend on the number of exercises the user has completed thus far and the degree of precision when completing the exercises. The plan of care can be generated, adjusted and/or corrected automatically by the system 100 based on the initial assessment or manually by the treating professional b.

In stage 720, CV module 150 detects the user's face position in front of the camera 130. For example, in stage 520, CV module 150 using information from camera 130 may use image processing techniques to establish that a face is properly positioned in front of camera 130. According to embodiments of the present invention, the system 100 is configured to assist the user, for example, in the form of animation to confirm proper face positioning in front of the camera 130. The animation can be in the form of a contour, or a mask (crown, hat or bunny ears) made visible on top of the user's head image when the user's head is properly positioned in front of the camera 130.

In stage 740, CV module 150 determines a set of key points indicating the movements of the user's face features and muscles to provide the actual data model 280 of the user performing the exercise in real-time of.

In stage 760, the computer program 140 compares in real-time the actual data model 280 to the reference model 295.

In stage, 765 the computer program 140 interprets the comparison of the actual data model 280 to the reference model 295 to determine whether a result of the comparison between the actual data model 280 and the reference model 295 is within predetermined parameters.

In stage 770, the computer program 140 generates feedback 155 in real-time based on the interpretation. For example, feedback may indicate whether or not the user is following the proper form of the exercise or properly makes the required sound. Further, the feedback 155 can include recognition of mistakes made by the user during the performance of the exercise, and recommendation and instruction as to how to improve the user's performance. The feedback 155 can be in the form of text, voice, animation or combination of various techniques known in the art.

In stage 790, the computer program 140 generates the reports 157. The reports 157 can include a real-time report, report of user's statistics, progress reports, recommendations and other information that can be used by treating professionals, such as SLPs, special care centers, schools, hospitals, insurance companies and the like.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, mobile devices or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented automated speech and language system to assist in correcting speech and language disorders in children and adults, the system comprising:
a device connected to a camera;
a processor; and
a non-transitory machine-readable medium comprising instructions stored therein, which when executed by the processor, cause the processors to perform operations comprising:
accessing or creating a user profile;
selecting an exercise to be performed by a user;
detecting the user's face and alignment in front of the camera;
determining a face key point data;
determining an actual data model based on the face key point data;
determining a reference model based on a correct performance of the exercise scaled for physical characteristics of the user;
comparing the actual data model with the reference model;
interpreting whether a result of the comparison between the actual data model and the reference model is within predetermined parameters; and
providing a feedback based on the interpretation of the result of the comparison between the actual data model with the reference model.

2. The system according to claim 1, wherein the physical characteristics of the user comprise actual facial contour and physical features.

3. The system according to claim 1, wherein the operations further comprise generating a rating and a report.

4. The system according to claim 3, wherein the operations further comprise:
determining a baseline for the user based on initial assessment of the user;
determining a treatment goal based on the baseline; and
providing an individualized plan of care that contains a personalized set of exercises to be performed by the user to achieve the treatment goal; and
updating the individualized plan of care based on the feedback, the rating and the report.

5. The system according to claim 4, wherein the baseline comprises evaluation of user's facial structure, jaw assessment, bite and teeth assessment, lip assessment, and language assessment.

6. The system according to claim 1, wherein the face key point data comprises:
a set of key points indicating movements of the user's face features and muscles.

7. The system according to claim 6, wherein the set of key points are from about 90 to about 120 key points.

8. The system according to claim 1, wherein the feedback is in the form of text, voice, and/or animation.

9. The system according to claim 8, wherein the feedback comprises:
recognition of mistakes made by user during performance of the exercise; and
recommendation and instruction for improving the user's performance.

10. The system according to claim 1, wherein the feedback is generated in real-time.

11. The system according to claim 3, wherein the report comprises:
progress statistics of the user;
recommendations for improvement of performance of the exercise by the user; and
additional information used by treating professionals, special care centers, schools, hospitals, and insurance companies.

12. The system according to claim 1, wherein the face key point data comprises a multidimensional face model data, wherein the multidimensional face model data is determined separately, simultaneously and is interdependent.

13. A computer-implemented automated method to assist in correcting speech and language disorders in children and adults, the method comprising:
accessing or creating a user profile;
selecting an exercise to be performed by a user;
detecting the user's face and alignment in front of the camera;
determining a face key point data;
determining an actual data model based on the face key point data;
determining a reference model based on a correct performance of the exercise scaled for physical characteristics of the user;
comparing the actual data model with the reference model;
interpreting whether a result of the comparison between the actual data model and the reference model is within predetermined parameters; and
providing a feedback based on the interpretation of the result of the comparison between the actual data model with the reference model.

14. The method of claim 13 further comprising of:
generating a rating and a report.

15. The method of claim 14 further comprising of:
determining a baseline for the user based on initial assessment of the user;
determining a treatment goal based on the baseline; and
providing an individualized plan of care that contains a personalized set of exercises to be performed by the user to achieve the treatment goal; and
updating the individualized plan of care based on the feedback, the rating and the report.

16. The method of claim 13, wherein the face key point data comprises:
a set of key points indicating movements of the user's face features and muscles.

17. The method of claim 13, wherein the feedback comprises:
recognition of mistakes made by user during performance of the exercise; and
recommendation and instruction for improving the user's performance.

18. The method of claim 13, wherein the feedback is generated in real-time.

19. The method of claim 13, wherein the report comprises:
progress statistics of the user;
recommendations for improvement of performance of the exercise by the user; and
additional information used by treating professionals, special care centers, schools, hospitals, and insurance companies.

20. The method of claim 13, wherein the face key point data comprises multidimensional face model data, wherein the multidimensional face model data is determined separately, simultaneously and is interdependent.
